(19) United States
(12) Patent Application Publication
(10) Pub. No.: US 2026/0261647 A1
(43) Pub. Date: Sep. 3, 2026

(54) METHOD AND APPARATUS TO EXTEND FIELD OF VIEW OF AN AUGMENTED REALITY DEVICE

(71) Applicant: QUALCOMM Incorporated, San Diego, CA (US)

(72) Inventors: Zhiping PANG, Shanghai (CN); Junliang CAI, Shenzhen (CN); Yanhong LIU, Shanghai (CN); Junxin WU, ShenZhen (CN); Shumao XIA, Shenzhen (CN); Yonggang HU, Shenzhen (CN); Yuan GAO, Shanghai (CN); Xuesong YANG, Shanghai (CN); Xin ZHOU, Shanghai (CN)

(21) Appl. No.: 18/993,199

(22) PCT Filed: Aug. 23, 2022
(86) PCT No.: PCT/CN2022/114211

§ 371 Date: Jan. 10, 2025

(51) Int. Cl. H04N 13/398; H04N 13/239; H04N 13/344; H04N 13/366

(52) U.S. Cl. CPC H04N 13/398; H04N 13/239; H04N 13/344; H04N 13/366; H04N 2213/008

(57) ABSTRACT

Disclosed are methods and systems for extending the field of view of an augmented reality (AR) device. In some aspects, an AR device establishes communications between an AR device having an image sensor and a display device having a display screen, time-synchronizes the display device to the AR device, determines a position of the display screen of the display device relative to the AR device, configures content to be rendered on the display device, and sends the content to the display device. In some aspects, the AR device determines its position based at least in part on visual information received by the image sensor while ignoring visual information within the display screen of the display device. In some aspects, the display device comprises a three-dimensional (3D) display and the AR device comprises at least one lens through which the user can view the 3D images shown by the 3D display.

### CROSS-REFERENCE TO RELATED APPLICATIONS

The present Application for Patent is a national stage application, filed under 35 U.S.C. § 371, of International Patent Application No. PCT/CN2022/114211, entitled “METHOD AND APPARATUS TO EXTEND FIELD OF VIEW OF AN AUGMENTED REALITY DEVICE,” filed Aug. 23, 2022, which is assigned to the assignee hereof and expressly incorporated herein by reference in their entirety.

### BACKGROUND OF THE DISCLOSURE

### 1. Field of the Disclosure

Aspects of the disclosure relate generally to augmented reality.

### 2. Description of the Related Art

As used herein, extended reality (XR) is an umbrella term that includes virtual reality (VR), mixed reality (MR), and augmented reality (AR). In VR, the user wears a VR headset that presents a view of the world that is entirely computer generated-the user does not see the real world at all. In MR, the user is seeing a mix of an image of the real world as seen through a video camera and computer-generated images, displayed together on a VR headset. In AR, the user sees the real world directly, e.g., through transparent lenses in front of the user's eye(s), in a device that also displays computer generated images on the transparent lenses.

XR devices have distinct disadvantages. For example, VR headset users are blind to the real world and can injure themselves and others, e.g., by running into furniture, pets, people, or other obstacles while using the VR headset. MR devices present a real-world view, but at lower resolution and often with some lag due to processing the video image. AR devices allow the user to see the real world directly but are limited to what they can show to the user.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method, performed by an augmented reality (AR) device, for using a display screen to extend the field of view of the AR device includes establishing communications between an AR device having an image sensor and a display device having a display screen; time-synchronizing the display device to the AR device; determining a position of the display screen of the display device relative to the AR device; configuring content to be rendered on the display device; and sending the content to the display device.

In an aspect, a method, performed by a display device having a display screen, for using the display screen to extend field of view of an AR device, includes establishing communications between a display device having a display screen and an AR device having an image sensor; time-synchronizing the display device to the AR device; determining a position of the AR device relative to the display device; receiving a request to display at least one object according to the position of the AR device; and displaying, on the display screen, the at least one object according to the position of the AR device.

In an aspect, an AR device includes at least one lens through which a user can view a display; a projector for projecting an AR image onto the at least one lens for viewing by the user; an image sensor; a memory; at least one transceiver; and at least one processor communicatively coupled to the projector, the memory, and the at least one transceiver, the at least one processor configured to: establish communications with a display device having a display screen; time-synchronize the display device to the AR device; determine a position of the display screen of the display device relative to the AR device; configure content to be rendered on the display device; and send the content to the display device.

In an aspect, a display device includes a display screen; a memory; at least one transceiver; and at least one processor communicatively coupled to the display screen, the memory, and the at least one transceiver, the at least one processor configured to: establish communications with an AR device; synchronize a timestamp with the AR device; receive, via the at least one transceiver, a position of the AR device; receive, via the at least one transceiver, a request to display at least one object according to the position of the AR device; and display, on the display screen, the at least one object according to the position of the AR device.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates portions of an augmented reality (AR) headset for using a display screen to extend field of view of an AR device, according to aspects of the disclosure.

FIG. 2 is a block diagram illustrating a system for using a display screen to extend field of view of an AR device, according to aspects of the disclosure.

FIG. 3A and FIG. 3B are flowcharts illustrating portions of a process associated with using a display screen to extend field of view of an AR device, according to aspects of the disclosure.

FIG. 4 is a flowchart illustrating a process associated with using a display screen to extend field of view of an AR device, according to aspects of the disclosure.

FIG. 5 is a flowchart illustrating a portion of a process associated with using a display screen to extend field of view of an AR device, according to aspects of the disclosure.

FIG. 6 is a flowchart illustrating another portion of a process associated with using a display screen to extend field of view of an AR device, according to aspects of the disclosure.

FIG. 7 illustrates a visual example of using a display screen to extend field of view of an AR device, according to aspects of the disclosure.

FIG. 8 is a flowchart of an example process associated with using a display screen to extend field of view of an AR device, according to aspects of the disclosure.

FIG. 9 is a flowchart of an example process associated with using a display screen to extend field of view of an AR device, according to aspects of the disclosure

### DETAILED DESCRIPTION

Disclosed are methods and systems for extending the field of view of an augmented reality (AR) device. In some aspects, an AR device establishes communications between an AR device having an image sensor and a display device having a display screen, time-synchronizes the display device to the AR device, determines a position of the display screen of the display device relative to the AR device, configures content to be rendered on the display device, and sends the content to the display device. In some aspects, the AR device determines its position based at least in part on visual information received by the image sensor while ignoring visual information within the display screen of the display device. In some aspects, the display device comprises a three-dimensional (3D) display and the AR device comprises at least one lens through which the user can view the 3D images shown by the 3D display.

These techniques include combining an AR headset with 3D TV glasses, so that the user can see through an AR display to see an on-working 3D TV. As used herein, the term “on-working” display refers to a display that supports XR, that is turned on, and that shows, or is ready to show, something on the display screen. In some aspects, a timestamp or other synchronization signal is used to synchronize all of the on-working screens in the room, e.g., so that all of on-working 3D screens in the room display the left eye image at the same time, then all of the on-working 3D screens in the room display the right eye image at the same time, etc. Multiple screens can be combined to form a larger display, such as a TV wall. In the examples described below, the term “display” will be presumed to refer to an on-working display unless specifically identified as otherwise.

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Three dimensional (3D) television, or 3DTV, is a technology which displays a simulated 3D world to a view of the device, e.g., by providing two different images to each eye of the viewer to produce parallax to simulate placement of the displayed object in a 3D field. 3DTV programs, however, are not interactive, i.e., what is displayed on the 3DTV does not change based on the position of the viewer relative to the screen. Instead, the 3DTV displays an image that would be seen from a fixed point, e.g., from the viewpoint of a person centered in front of the screen and viewing the screen head-on rather than at an angle. This is necessary in part because a 3DTV program may be viewed by multiple viewers at the same time and a 3DTV cannot provide a unique view for every separate viewer at every viewer's separate position, so the displayed content is created presuming a single, front-and-center viewer. Consequently, conventional 3DTVs do not need or care to know a viewer's location and orientation, do not include any capability to determine this information, and thus are unsuitable for (incapable of) XR applications. As mentioned above, AR devices provide a direct view of the real world, but have a limited field of view, e.g., about 50 degrees, which is much less than the human field of view, which is about 190 degrees side to side. Also an AR headset cannot create entirely new scenes or landscapes but can only overlay images or information on top of existing scenes or landscapes.

In order to overcome this shortcoming of AR devices, methods and systems of extending AR using a 3D display such as used by a 3DTV (herein referred to as a “3D display”) are herein presented. By coupling an AR headset with a 3D display, the AR experience is greatly enhanced. For example, the 3D display can provide a very beautiful, very detailed 3D scene directly to the user through the glass of the AR headset—i.e., the virtual image is generated by the 3D display rather than by the AR headset. When the end user walks around, the view of the 3D scene presented to the user will change, giving the illusion that the user is looking through the 3D display as if it were a window into another world. As the user approaches the 3D display, more or that virtual world is shown on the screen of the 3D display; as the user moves away from the 3D display, less of that virtual world is shown on the screen of the 3D display; as the user walks past the 3D display, the view of the virtual world shown to the user on the screen of the 3D display changes; all of these just as if the user were walking towards, away from, or past an actual window.

Coupling an AR device with a 3D display can enrich the user's experience in other ways, as well. For example, in some aspects, the user can pull objects out of the 3D world presented by the 3D display to the AR glass to view the details, and push them back into the 3D world for storage, to choose another object to pull out, etc.

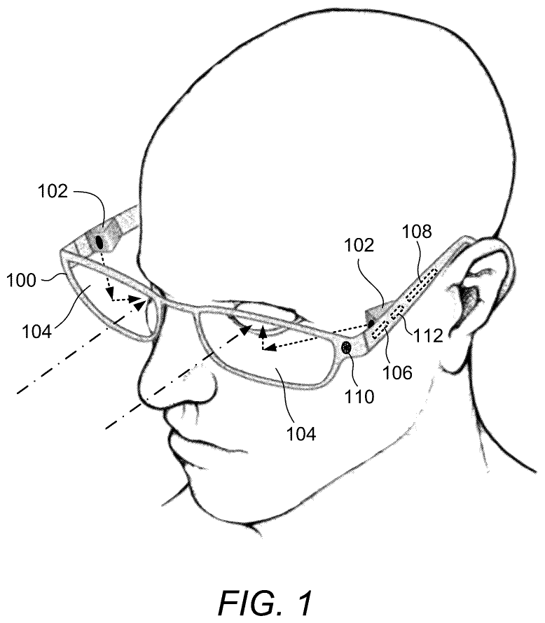

FIG. 1 illustrates portions of an AR headset 100 for using a display screen to extend field of view of an AR device, according to aspects of the disclosure. In the example shown in FIG. 1, the AR headset 100 includes at least one projector 102 that projects an AR image onto a pair of lenses 104, which are made of glass, plastic, or some other transparent material so that the viewer has an unobstructed view of the real world. The lenses 104 are angled so as to reflect the AR image into the user's eye. The number of lenses in the AR headset 100 is illustrative and not limiting. In alternative aspects, the projector 102 may project an AR image onto different portions of a single lens, which may include an optical waveguide, for example. Likewise, the AR headset 100 may have more than two lenses.

The two lenses 104 provide different views of the AR image to each eye, e.g., because each lens 104 reflects an image from its respective projector 102, as shown in FIG. 1, or because each lens 104 reflects a different portion of one image provided by a single projector, e.g., that may be mounted above both eyes (this embodiment not shown in FIG. 1). In some aspects, the different images provided to each eye by the one or more projectors 102 cause the projected image to appear to be in three dimensions. The transparent lenses allow the user to directly see images on a display screen. As will be explained in detail below, the display screen can be used to extend the field of view of the AR device.

In some aspects, the lenses 104 also provide two different views of an image that is displayed by each of one or more 3D display screens. The different views provided to each eye by a 3D display screen cause the image within the 3D display to appear to be in three dimensions. Thus, in some aspects, the user will see a real world image, a 3D image within each 3D display screen, and optionally another 3D image produced by the one or more projectors 102.

In some aspects, the lenses are polarized lenses, with the lens for one eye having a different polarization orientation than the lens for the other eye. This type of lens is used for 3D displays that project two different images simultaneously, each image at a different polarization orientation from the other so that one image is seen by one eye and the other image is seen by the other eye. Because the two images produced by the 3D display and seen by each eye are slightly different from each other, the image on the 3D display appears to the user as a 3D image. This only applies to the images being displayed by the 3D displays—the real world image and any images produced by the projector(s) 102 are not affected by the polarization.

In some aspects, the lenses are liquid crystal display (LCD) lenses that operate as electronic light shutters, where the two lenses alternate being open, e.g., when one of the lenses is transparent the other lens is opaque, and vice versa. This type of lens is used for 3D displays that project two different images in a time domain multiplexed fashion, e.g., alternating between the two images in time. Because the alternating images produced by the 3D display and seen by each eye are slightly different from each other, the image on the 3D display appears to the user as a 3D image. This only applies to the images being displayed by the 3D displays—the real world image and any images produced by the projector(s) 102 are not affected by the alternating shutters.

In the example illustrated in FIG. 1, a single set of lenses 104 are used both as a surface upon which the AR image is displayed and also as polarizing lenses or light shutters for use with the 3D display. However, in another aspect, a first set of lenses may be used as the surface upon which the AR image is displayed, and a second set of lenses are the polarizing lenses or light shutters needed by the 3D display. Having two sets of lenses allows each set to be of a size, location, and orientation best suited for the particular need—i.e., either as the reflective surface upon which the AR image is displayed or as the lens needed by the 3D display.

In the example shown in FIG. 1, the AR headset 100 includes a controller 106 controls the operation of the projectors 102, and may include a wireless transceiver 108 for communicating via Wifi, Bluetooth, cellular, or other wireless communication links.

In the example shown in FIG. 1, the AR headset 100 includes an image sensor 110, e.g., a camera, that captures views of the local environment and may use those images to determine the position and orientation of the AR headset 100.

In the example shown in FIG. 1, the AR headset 100 includes an inertial measurement unit (IMU) 112, that provides inertial data to the controller 106, which may use that IMU data to predict a position and/or orientation of the AR headset 100 as the user moves around in the real world.

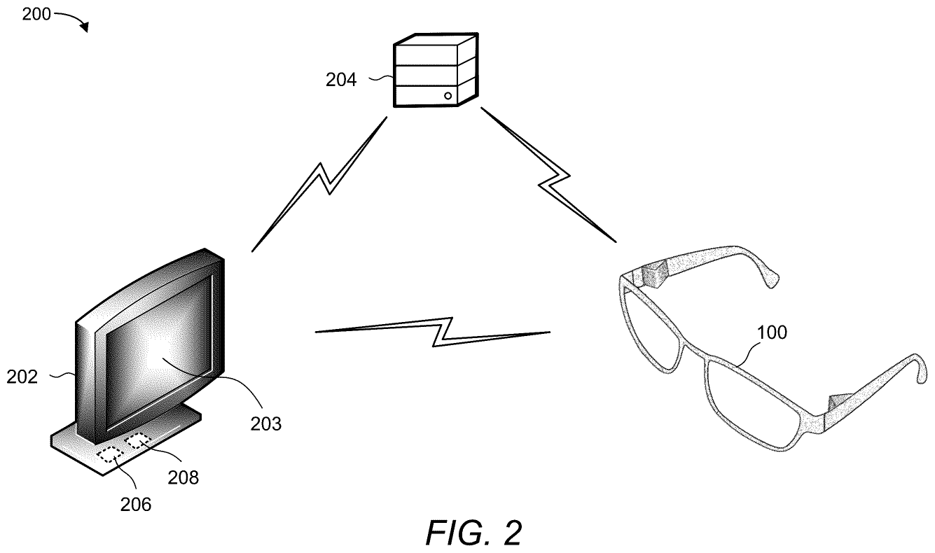

FIG. 2 is a block diagram illustrating an AR system 200 for using a display screen to extend field of view of an AR device, according to aspects of the disclosure. In the example illustrated in FIG. 2, an AR headset 100 is communicatively coupled to one or more display devices 202, each with one or more display screens 203, e.g., through one or more controllers, such as controller 204. In some aspects, the one or more display devices 202 may comprise at least one 3D display for displaying pairs of images to simulate a 3D image. In some aspects, the controller 204 may be part of the AR headset 100. In some aspects, the controller 204 may be part of one or more of the display devices 202. In some aspects, the controller 204 may be separate from the AR headset 100 and the one or more display devices 202. For example, the controller 204 may be, or may be part of, a set top box (STB), a media server, a streaming platform, a game console, a personal computer (PC), or other computing source. In the example illustrated in FIG. 2, the display device 202 includes its own controller 206 and a wireless transceiver 208. The AR headset 100, the one or more display devices 202 and their respective controllers 206, and the controller 204 may communicate with each other via wired or wireless connections. In some aspects, the AR headset 100 may communicate with multiple 3D screens, each having a dedicated controller, where the headset controller and 3D screen controllers work as a cloud to decide/calculate the views to be displayed by the 3D screens and/or the AR headset 100.

In some aspects, the AR headset 100 communicates exclusively with the controller 204, and the controller 204 handles the exchange of information and data between the AR headset 100 and each of the one or more display devices 202. In some aspects, the AR headset 100 may communicate with the one or more display devices 202 directly as well as with the controller 204.

In some aspects, the AR headset 100 is system master, e.g., sending instructions to the controller 204 and optionally to the one or more display devices 202. In some aspects, the controller 204 operates as the system master, e.g., sending instructions to the AR headset 100 and to the one or more display devices 202.

It will be noted that any of the wireless communications links described herein may instead be a wired communication link, and vice-versa. For example, the AR headset 100 may connect to the controller 204 via a wireless communication link while the controller 204 may connect to the display device 202 via a wired communication link, and so on. Examples of wireless communications links include, but are not limited to, WiFi, cellular, Bluetooth, etc. In some aspects, the AR headset 100 and/or the controller 204 may connect to multiple devices of each kind. For example, a controller 204 may connect to an AR headset 100 and multiple display devices 202.

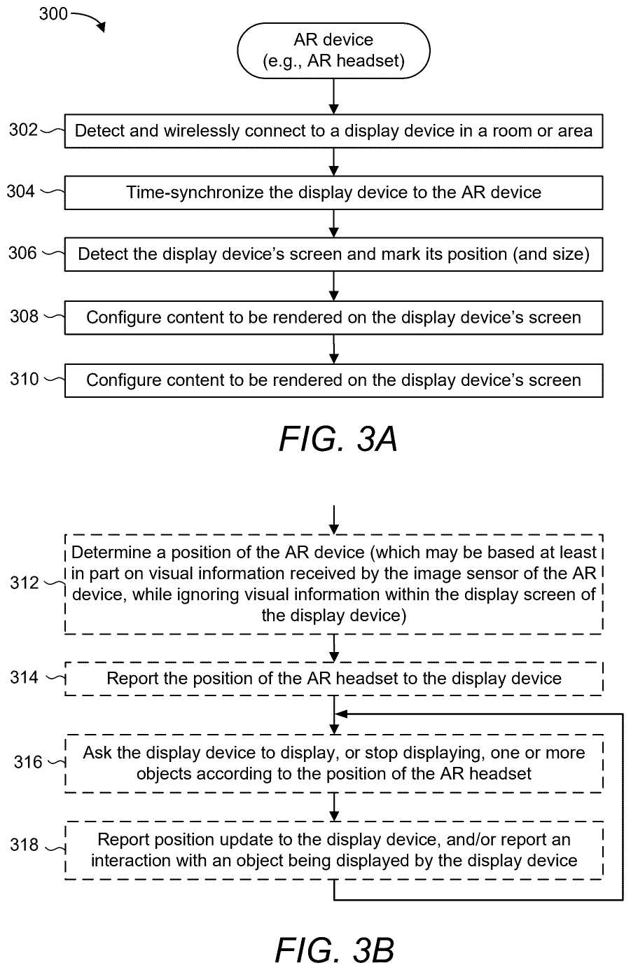

FIG. 3A and FIG. 3B are flowcharts illustrating portions of a process 300 associated with using a display screen to extend field of view of an AR device, according to aspects of the disclosure. In some implementations, one or more blocks of FIGS. 3A and 3B may be performed by one or more components within an AR system 200 (e.g., AR headset 100, display devices 202, controller 204, etc.). In some implementations, one or more blocks of FIGS. 3A and 3B may be performed by another device or groups of devices separate from the AR system 200.

As shown in FIG. 3A, process 300 may include, at block 302, detecting and wirelessly connecting to a display device in a room or area. For example, an AR headset 100 may join a WiFi or other wireless network—that may be hosted by the controller 204 or by a wireless router or some other device—and determine that a display device 202 is also on that wireless network, e.g., by issuing a general query and detecting a response from the display device 202, by receiving a notification message that was broadcast by the display device 202, etc. Likewise, the AR headset 100 may connect to the display device 202 directly in a peer-to-peer fashion rather than via a WiFi network, e.g., via a Bluetooth or other wireless connection. In some aspects, the display device may be a 3D display that displays pairs of images to simulate a 3D image.

As shown in FIG. 3A, process 300 may further include, at block 304, time-synchronizing the display device to the AR device. For example, the AR headset 100 may exchange timestamp messages with the display device 202, the controller 204, or both. Once synchronized, the AR headset 100 is synchronized with the display device. This synchronization includes, but is not limited to, synchronizing the light shutters within the AR headset 100 to the alternating views presented by a 3D display. In some aspects, the display device 202 may display a calibration sequence that includes a timestamp displayed or encoded within the image, which AR headset 100 receives (e.g., via a camera, image sensor, light sensor, etc.), decodes, and uses to time-synchronize with the display device 202.

As shown in FIG. 3A, process 300 may further include, at block 306, detecting the screen of the display device and marking its position, and, optionally, also its size. For example, the display device 202 may present, on its screen, a test pattern, a black screen, or other visual display that the AR headset 100 can detect and identify as the display screen 203 of the display device 202, e.g., using its image sensor 110. As the user of the AR headset 100 moves, the change of size, shape, aspect ratio, etc., of the detected display screen 203 may be used to calculate the relative position of the display device 202 to the AR headset 100. In some aspects, the AR headset 100 can receive, from the display device 202 and/or the controller 204, information about the dimensions of the display screen 203, information about the location of the display device 202, other information about the display device 202, or some combination thereof, which the AR headset 100 may use to detect and identify the display screen 203.

As shown in FIG. 3A, process 300 may include, at block 308, configuring content to be rendered on the display screen of the display device. For example, the AR headset 100 may generate a synthetic scene to be displayed by the display device so that the synthetic scene is visible to the user of the AR headset 100 through the transparent lens or lenses of the AR headset 100. Examples of a synthetic scene may include, but are not limited to, a 3D landscape, e.g., such that the screen of the display device appears as a window through which the 3D landscape may be viewed.

As shown in FIG. 3A, process 30 may include, at block 310, sending the content to the display device. For example, the AR headset 100 may transmit the content to the display device 202 via the wireless connection between them.

As shown in FIG. 3B, process 300 may optionally include, at block 312, determining a position of the AR device. In some aspects, the AR device may use wireless RF techniques, such as using ultra-wideband (UWB) positioning methods, or receiving an indication of its position from another entity. In some aspects, the AR device can derive relative positions from absolute positions. In some aspects, the AR device may determine its position based at least in part on visual information received by the image sensor (which may occur during calibration), such as virtual simultaneous localization and mapping (vSLAM) positioning methods, while ignoring visual information within the display screen 203 of the display device. This is because the images being displayed on the display screen 203 will be synthetic and should not be used to calculate a position or orientation of the AR headset 100; instead, only images of real objects (e.g., not anything being shown by the display screen 203) should be used for this calculation. In some aspects, determining a position of the AR device comprises performing a six degree of freedom (6DOF) calculation.

As shown in FIG. 3B, process 300 may optionally include, at block 314, reporting the position of the AR headset 100 to the display device 202. For example, after the AR headset 100 has performed its 6DOF calculation to determine its position and orientation relative to the room, the AR headset 100 or the controller 204 may report the position of the AR headset 100 to the display device 202. In some aspects, the display device 202 is notified only of the position of the AR headset 100 in the room; with this information, the display device 202 can calculate a view to be shown to the user of the AR headset 100 via the display screen 203. In some aspects, the display device 202 is also notified of the orientation of the AR headset 100 relative to the room and/or the display screen 203. This allows the display device 202 to stop displaying an image (and thus save power) if the user of the AR headset 100 is facing away from the display screen 203 and can't see it anyway and to start displaying the image when the user of the AR headset 100 can see the display screen 203, for example.

As shown in FIG. 3B, process 300 may optionally include, at block 316, asking the display device to display, or stop displaying, one or more objects according to the position of the AR headset. In some aspects, the AR headset 100 indicates to the display device 202 that the user is facing the display screen 203, which may be considered a request to display the previous scene, some default scene, or other scene. In some aspects, the user of the AR headset 100 may request the display device 202 to display a particular view or scene, e.g., by selecting an option using a controller, by speaking a command, by performing a hand gesture, or by performing some other agreed-upon action recognized by the AR system 200.

As shown in FIG. 3B, process 300 may further include, at block 318, reporting a position update (and, optionally, an orientation update) to the display device 202, reporting an interaction with an object being displayed by the display screen 203, or some combination thereof. For example, as the user of the AR headset 100 moves around the physical room in which the display device 202 is located, the display device 202 is updated with the new position of the AR headset 100 and will adjust the image displayed on the display screen 203 accordingly to match how an image of a real world scene viewed through a window would change as the user's position relative to that window would change. In another example, the display device 202 may start by displaying nothing at all until the AR headset 100 requests that the display device 202 start to display something-e.g., some scene, object, or combination thereof. While the display device 202 is not displaying anything, the AR headset 100 may continue to report its position to the display device 202, so that when the AR headset 100 does ask the display device 202 to display something, the display device 202 already knows the position of the AR headset 100 and can display the requested scene or object without delay.

Likewise, a user of the AR headset 100 may interact with an object being displayed by the display device 202, e.g., by selecting an option using a controller, by speaking a command, by performing a hand gesture, by performing some other agreed-upon action recognized by the AR system 200, etc. For example, if the display screen 203 is presenting one or more virtual objects on a virtual shelf, and the user selects a virtual object for closer inspection (e.g., by making a grabbing gesture detected by the AR headset 100, pushing buttons on a controller connected to the AR headset 100, selecting pulldown menus being displayed by the AR headset 100, etc.), the AR headset 100 may notify the display device 202 of this interaction. In response, the display device 202 may change the image being displayed on the display screen 203, e.g., changing the shape and/or color of the objects, highlight the objects, zooming in on the selected object, moving the selected object out of the display screen 203 and displaying it instead using the AR headset 100, etc. In some aspects, a virtual object being displayed on the AR headset 100 may be moved to the display screen 203 such that the display screen 203 displays the object, which is seen by the user through the transparent lenses of the AR headset 100, rather than having the AR headset 100 generate an image of the virtual object and display it on the lenses, e.g., using the projector(s) 102. Examples of virtual objects include, but are not limited to, pictures, videos, vector graphics, and 3D models, such as 3D models written in Unity, DirectX, or OpenGL, and that are described by shape, texture, lighting, and so on. For example, when a 3D model is transferred back and forth from an AR headset 100 to a display device 202, that AR headset 100 may render the 3D model in a position and pose relative to the display device 202 or relative to the AR headset 100, and may also render the 3D model as if it was lit by the real world environment of the user of the AR headset 100. The AR headset 100 may also modify other attributes of the 3D model, such as size, texture, lighting, resolution, and so on.

In the simplified process 300 shown in FIG. 3, block 316 and block 318 are repeated continually until the AR system is turned off or that specific operation is terminated. However, it will be appreciated that, in some aspects, the detection and use of additional display screens may happen in parallel, and the operations of blocks 302 through 318 may be repeated for each of the additional display screens detected. In some aspects, the AR system 200 will update object information, AR headset position, etc., with a timestamp, sensor data, frame order, shutter signal, etc., through virtual wireless connection channels. In aspects where there are multiple display screens, the multiple display screens may be synchronized to the same time base so that all of the display screens will show the left-eye image at the same time, then all of the display screens will show the right-eye image at the same time, regardless of where each display screen is located relative to the AR headset. For example, in some aspects, the display screens will all use a same vertical sync (VSYNC) signal or a same VSYNC signal timing.

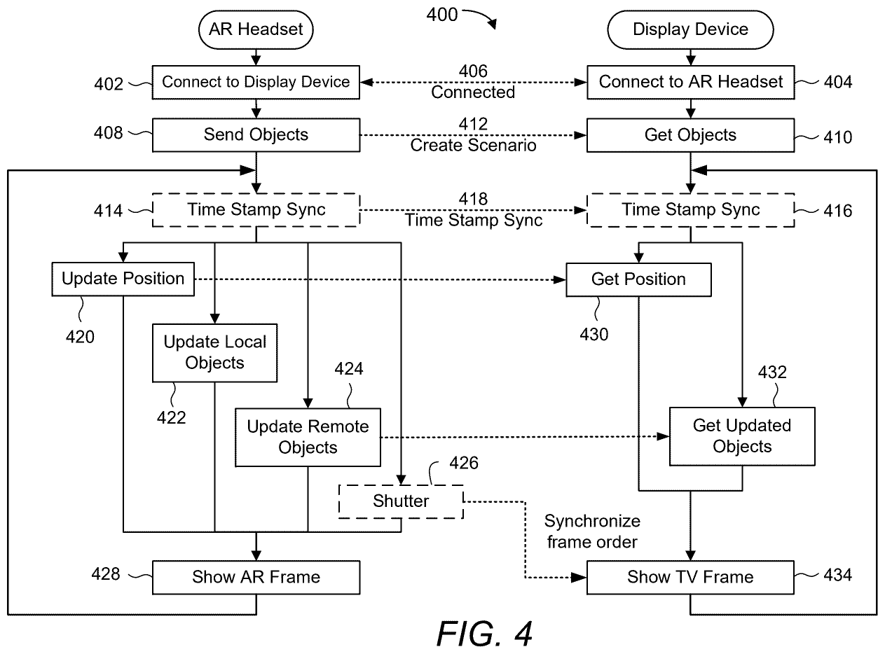

FIG. 4 is a flowchart illustrating another process 400 associated with using a display screen to extend field of view of an AR device, according to aspects of the disclosure. FIG. 4 illustrates an example interaction between an AR headset and a display device. In some aspects, the display device may be a 3D display device, such as a 3D TV. In some implementations, one or more blocks of FIG. 4 may be performed by one or more components within an AR system 200 (e.g., AR headset 100, display devices 202, controller 204, etc.). In some implementations, one or more blocks of FIG. 4 may be performed by another device or groups of devices separate from the AR system 200.

In the example shown in FIG. 4, at block 402, the AR headset connects to the display device, and at block 404, the display device connects to the AR headset. Upon completion of these two blocks, the AR headset and the display device have established a communication link between them (event 406).

In the example shown in FIG. 4, at block 408, the AR headset sends objects to the display device for the display device to display, and at block 410, the display device receives those objects. The AR headset can create a visual scenario containing one or more objects (event 412), which the display device will display towards the user of the AR headset. If the display device is a 3D display, then the AR headset can create a 3D scenario.

From the AR headset side, the AR headset enters a loop which may include one or more tasks. In some aspects, the AR headset may occasionally (e.g., at a low frequency) perform a time stamp sync (block 414) with the display device (block 416), e.g., using a time stamp synchronization signal or message (event 418). Where both the crystal oscillator (XO) of the AR headset and XO of the display device have an accuracy within 50 parts per million (ppm), for example, a crystal marked 1 MHz may actually have 999950 to 1000050 cycles per second. In a use case where the timestamp sync accuracy must be within 1 ms, a time stamp sync operation should occur every 10 seconds (1 ms/100 ppm) or more frequently.

Other tasks that the AR headset may perform during the loop include, but are not limited to, updating its position (block 420), updating local objects, e.g., objects that the AR headset will project onto its lenses (block 422), and updating remote objects, e.g., objects that the display device will display on its screen (block 424). If the AR headset is interfacing with a “shutter” type 3D display, it may optionally provide a shutter synchronization signal to the 3D display (block 426). The AR headset then shows the (possibly updated) AR frame (block 428).

From the display device side, the display device enters a loop which may include one or more tasks in addition to the low frequency time stamp sync (block 416), such as getting the updated position from the AR headset (block 430) and getting the updated remote objects from the AR headset (block 432). The 3D TV then shows the (possibly updated) display frame (block 434). If the display is a “shutter” type 3D TV, it may use the shutter synchronization signal from the AR headset to synchronize the alternating frames so that the image on the 3D TV is correctly seen by the user of the AR headset.

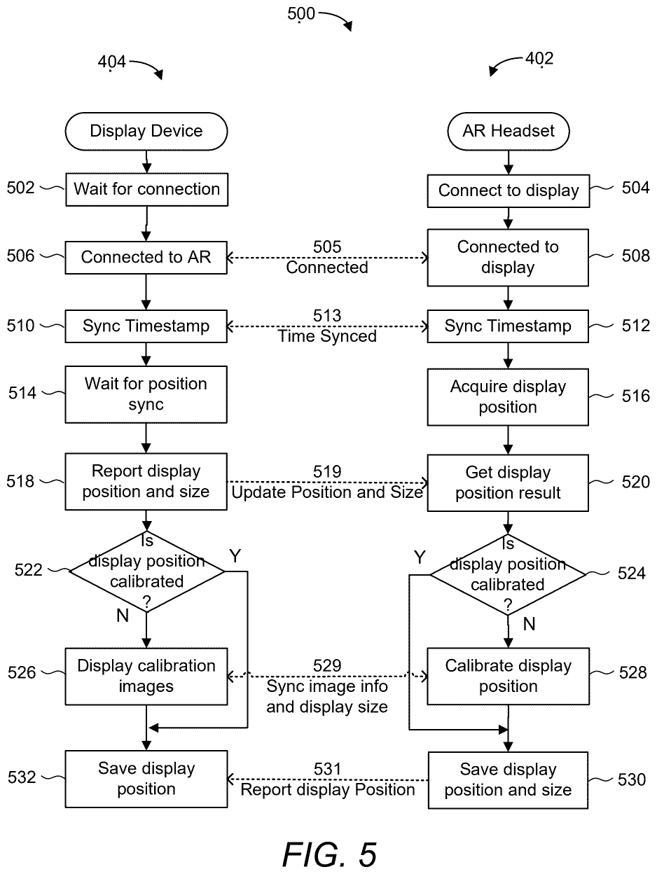

FIG. 5 is a flowchart illustrating another process 500 associated with using a display screen to extend field of view of an AR device, according to aspects of the disclosure. FIG. 5 shows the operation of block 402 and block 404 of FIG. 4 in more detail. In some implementations, one or more blocks of FIG. 5 may be performed by one or more components within an AR system 200 (e.g., AR headset 100, display devices 202, controller 204, etc.). In some implementations, one or more blocks of FIG. 5 may be performed by another device or groups of devices separate from the AR system 200.

In the example process 500 shown in FIG. 5, a display device waits for a connection from an AR headset (block 502) while the AR headset tries to establish that connection (block 504). After the connection is made (event 505), the display device is connected to the AR headset (block 506) and the AR headset is connected to the display device (block 508). The display device synchronizes its timestamp with the AR headset (block 510) and the AR headset synchronizes its timestamp with the display device (block 512). At this point, the AR headset and the display device are time-synced (event 513).

The display device then waits for the AR headset to determine the position of the display device (block 514). The AR headset begins determining the position of the display device (block 516). In the example shown in FIG. 5, the display device reports its position and screen size to the AR headset (block 518) and the AR headset uses this information (event 519) to get the position of the display device (block 520).

Both the display device and the AR headset check to see if the TV position is calibrated (block 522 and block 524, respectively). If not, the display device displays calibration images (block 526), which the AR headset uses to calibrate the position of the display device (block 528). The source of the calibration image can be the AR headset or the display device. If the calibration image is provided by the AR headset, the AR headset should send the image to display device; if the calibration image is provided by the display device, the display device should send the image or corner points information (e.g., the corner points' position and the descriptor) to AR headset (event 529). In some aspects, the AR headset then saves the position and size of the display device (block 530). In some aspects, the AR headset reports the position of the display device to the display device (event 531). In some aspects, the display device then saves its position for later use (block 532). At the conclusion of this process, the display device position is calibrated and the AR headset can more quickly connect to the display device in the future. The AR headset may then use the position and size of the display device screen to exclude images on that screen when calculating the position of the AR headset.

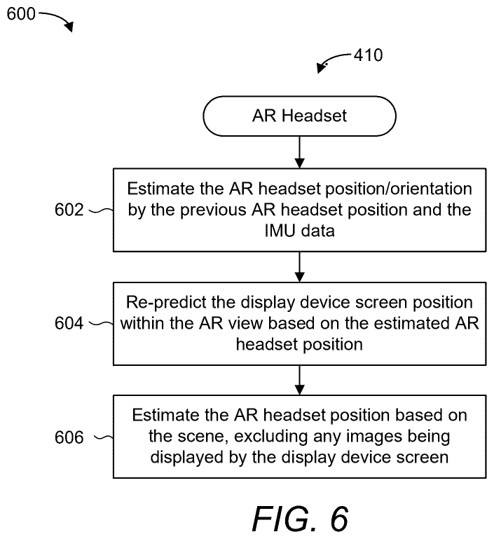

FIG. 6 is a flowchart illustrating another process 600 associated with using a display screen to extend field of view of an AR device, according to aspects of the disclosure. FIG. 6 shows the operation of block 410 of FIG. 4 in more detail. In some implementations, one or more blocks of FIG. 6 may be performed by one or more components within an AR system 200 (e.g., AR headset 100, display devices 202, controller 204, etc.). In some implementations, one or more blocks of FIG. 6 may be performed by another device or groups of devices separate from the AR system 200.

As shown in FIG. 6, process 600 may include, at block 602, estimating the AR headset position and/or orientation based on the previous AR headset position/orientation and inertial measurement unit (IMU) data. For example, an AR headset 100 may estimate its own position (and optionally, its own orientation) based on its previous position and its own IMU data.

As shown in FIG. 6, process 600 may further include, at block 604, reprojecting (re-predicting) the display device screen position and/or orientation based on the estimated AR headset position and/or orientation. For example, the AR headset 100 may calculate the position of the display device 202 relative to the current position of the AR headset 100.

As shown in FIG. 6, process 600 may further include, at block 606, estimating the AR headset position based on the scene, as viewed by the AR headset camera, but excluding any images that might currently be displayed by the display device. This allows a traditional, visually-based positioning estimation to be performed without having the images on the display device possibly confuse the calculation. In some aspects, this may involve estimating the position of the masked image, i.e., the AR headset may try to determine the exact position of the 3D screen relative to the AR headset's current position and orientation, and/or masking the camera image within the display device screen position, i.e., ignoring the portion of the AR headset's point of view that occurs within the screen of the display device. In this manner, the AR headset ignores anything that is currently being displayed by the display device while the AR headset is trying to determine its position in the room based on visual clues.

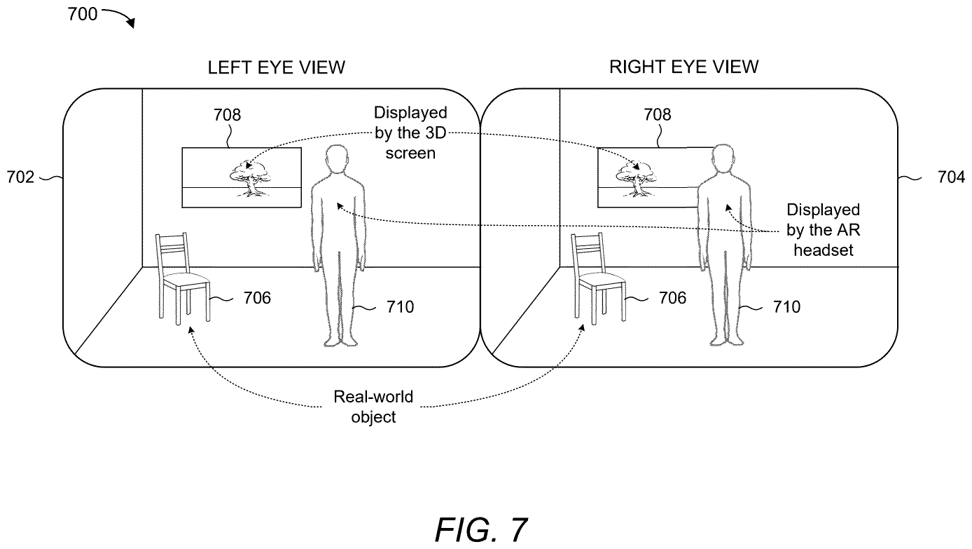

FIG. 7 illustrates an example 700 of using a display screen to extend field of view of an AR device, according to aspects of the disclosure. In the example shown in FIG. 7, the views seen by a user of an AR headset are shown, i.e., a left eye view 702 and a right eye view 704. In this example, the user is looking at a room that contains a chair 706 and a 3D screen 708.

In the example shown in FIG. 7, the 3D screen 708 is showing a 3D landscape containing a single tree. The position of the tree within the frame of the 3D screen is slightly different for each eye, giving the illusion that the user is looking out of an actual window at an actual tree in the near distance. To do this, the 3D screen is displaying two different views, one for the left eye to see and another for the right eye to see. This may be done, for example, by displaying two views simultaneously, each view being polarized at a different angle to match the respective polarizing angle of each lens of the AR headset, or by alternately displaying the two images in synchronization with LCD shutters on each lens of the AR headset so that only each eye sees the view intended for that eye. As the user moves around the physical room, the 3D images displayed by the 3D screen will change to reflect the new view that would be seen by an actual user looking through an actual window at an actual tree. In order to know what that view should be, the 3D screen receives continual updates regarding the position of the AR headset within the room. If the user turns his or her head but otherwise stays in the same location, the image on the 3D screen 708 would not need to change, except to perhaps make a minor adjustment for a slight change in position of the user's eyes.

In the example shown in FIG. 7, the AR headset is generating an AR image of an object 710. To do this, the AR headset projects images onto the lenses of the AR headset such that the images are reflected into the eyes of the user wearing the AR headset. The AR images presented to each eye are slightly different from each other, giving the illusion that the object 710 is physically present in the room. In FIG. 7, the object 710 appears closer to the 3D screen 708 in the right eye view than in the left eye view, just as a real world object would do. If the user turns his or her head but otherwise stays in the same location, the AR image of the object 710 that is projected onto the lenses would have to change to give the illusion that the object 710 remains in the same place in the room, unless of course the object 710 is intended to remain in constant position relative to the user rather than in constant position relative to the room.

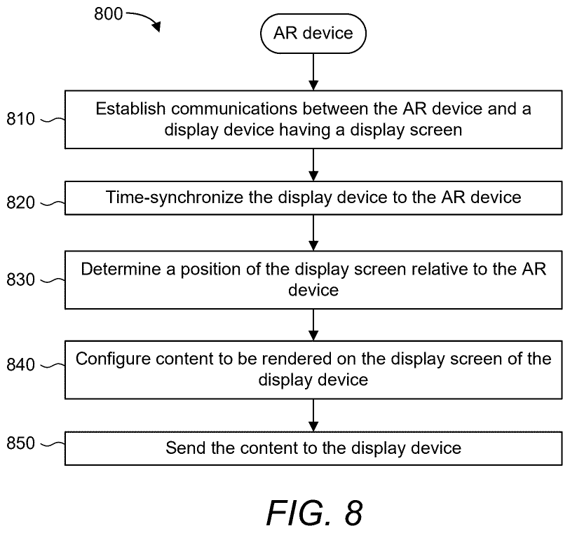

FIG. 8 is a flowchart of an example process, performed by an AR device, associated with using a display screen to extend field of view of the AR device, according to aspects of the disclosure. In some implementations, one or more process blocks of FIG. 8 may be performed by an AR device (e.g., AR headset 100, controller 204). In some implementations, one or more process blocks of FIG. 8 may be performed by another device or a group of devices separate from or including the AR device. Additionally, or alternatively, one or more process blocks of FIG. 8 may be performed by one or more components of an apparatus, such as a processor(s), memory, or transceiver(s), any or all of which may be means for performing the operations of process 800.

As shown in FIG. 8, process 800 may include, at block 810, establishing communications between the AR device and a display device having a display screen. Means for performing the operation of block 810 may include the processor(s), memory, or transceiver(s) of any of the apparatuses described herein. For example, the AR headset 100 may connect to at least one display device 202 having a display screen 203, using the wireless transceiver 108.

As further shown in FIG. 8, process 800 may include, at block 820, time-synchronizing the display device to the AR device. Means for performing the operation of block 820 may include the processor(s), memory, or transceiver(s) of any of the apparatuses described herein. For example, the AR headset 100 may synchronize a timestamp with each of the on-working display devices, using the wireless transceiver 108.

As further shown in FIG. 8, process 800 may include, at block 830, determining a position of the display screen relative to the AR device. In some aspects, the AR headset 100 may also determine a size of the display screen of the display device. Means for performing the operation of block 830 may include the processor(s), memory, or transceiver(s) of any of the apparatuses described herein. For example, the AR headset 100 may determine a position and/or size of a display screen 203 of each of at least one display device 202, using images captured by the image sensor 110.

As further shown in FIG. 8, process 800 may include, at block 840, configuring content to be rendered on the display screen of the display device. Means for performing the operation of block 840 may include the processor(s), memory, or transceiver(s) of any of the apparatuses described herein. For example, the AR headset 100 may configure content to be rendered on the display screen 203 of the display device 202 using the controller 106. In some aspects, the content is configured based at least in part on the position of the display device 202 relative to the AR headset 100.

As further shown in FIG. 8, process 800 may include, at block 850, sending the content to the display device. Means for performing the operation of block 850 may include the processor(s), memory, or transceiver(s) of any of the apparatuses described herein. For example, the AR headset 100 may send the content to the display device 202 using the wireless transceiver 108.

In some aspects, establishing communications between the AR device and the display device comprises establishing communications between the AR device and a plurality of display devices, and wherein the plurality of display devices operates as a large, unified display to provide a single view, as individual displays displaying different views, or a combination thereof.

In some aspects, the process 800 may further include, sending, to the display device, a time synchronization signal for synchronizing timing of images being displayed by the display device with an operation of the AR device.

In some aspects, process 800 includes determining a position of the AR device, reporting a position of the AR device to the display device, and requesting the display device to display at least one object according to the position of the AR device.

In some aspects, determining the position of the AR device comprises at least one of determining the position using radio frequency positioning techniques or determining a size of the display screen of the display device and determining a position of the AR device based at least in part on visual information received by the image sensor, while ignoring visual information within the display screen of the display device.

In some aspects, determining the position of the AR device comprises performing a six-degree of freedom (6DOF) calculation.

In some aspects, process 800 includes reporting, to the display device, a user interaction with at least one of the at least one object being displayed by the display device.

In some aspects, process 800 includes transferring an object being displayed by the display device to the AR device and displaying the object as an AR image, or transferring an object being displayed by the AR device as an AR image to the display device and ceasing displaying the object as an AR image.

In some aspects, the AR device comprises at least one lens through which the user can view a three-dimensional (3D) display for displaying pairs of images to simulate a 3D image, and wherein the display device comprises a 3D display.

Process 800 may include additional implementations, such as any single implementation or any combination of implementations described below and/or in connection with one or more other processes described elsewhere herein. Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

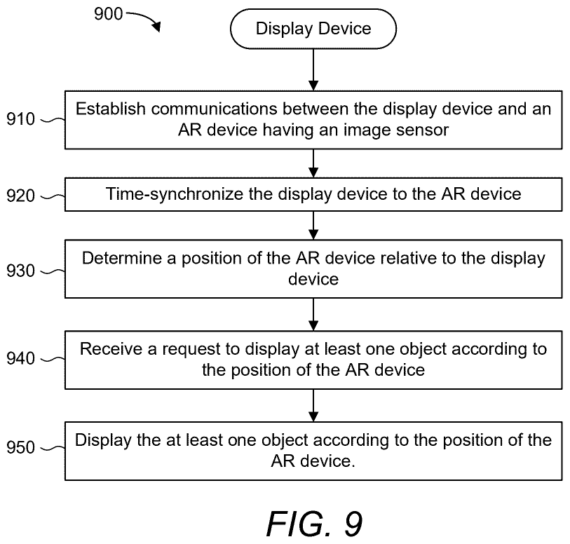

FIG. 9 is a flowchart of an example process, performed by a display device, associated with using a display screen of the display device to extend field of view of an augmented reality (AR) device, according to aspects of the disclosure. In some implementations, one or more process blocks of FIG. 9 may be performed by a display device (e.g., display device 202). In some implementations, one or more process blocks of FIG. 9 may be performed by another device or a group of devices separate from or including the display device. Additionally, or alternatively, one or more process blocks of FIG. 9 may be performed by one or more components of an apparatus, such as a processor(s), memory, or transceiver(s), any or all of which may be means for performing the operations of process 900.

As shown in FIG. 9, process 900 may include, at block 910, establishing communications between the display device and an AR device having an image sensor. Means for performing the operation of block 910 may include the processor(s), memory, or transceiver(s) of any of the apparatuses described herein. For example, the display device 202 may connect to an AR headset 100 using the wireless transceiver 208.

As further shown in FIG. 9, process 900 may include, at block 920, time-synchronizing the display device to the AR device. Means for performing the operation of block 920 may include the processor(s), memory, or transceiver(s) of any of the apparatuses described herein. For example, the display device 202 may synchronize a timestamp with the AR headset 100, using the wireless transceiver 208.

As further shown in FIG. 9, process 900 may include, at block 930, determining a position of the AR device relative to the display device. Means for performing the operation of block 930 may include the processor(s), memory, or transceiver(s) of any of the apparatuses described herein. For example, the display device 202 may receive a position of the AR headset 100, using the wireless transceiver 208.

As further shown in FIG. 9, process 900 may include, at block 940, receiving a request to display at least one object according to the position of the AR device. Means for performing the operation of block 940 may include the processor(s), memory, or transceiver(s) of any of the apparatuses described herein. For example, the display device 202 may receive a request to display at least one object according to the position of the AR headset 100, using the wireless transceiver 208.

As further shown in FIG. 9, process 900 may include, at block 950, displaying the at least one object according to the position of the AR device. Means for performing the operation of block 950 may include the processor(s), memory, or transceiver(s) of any of the apparatuses described herein. For example, the display device 202 may display the at least one object according to the position of the AR headset 100, using the controller 206 to calculate the position and location of the object within the visual field of the user. In aspects where the display device 202 is a 3D display, the controller 206 may calculate a pair of images required to display the 3D object from the perspective of the current position of the AR headset 100.

In some aspects, the display device comprises a three-dimensional (3D) display for displaying pairs of images to simulate a 3D image.

In some aspects, determining the position of the AR device relative to the display device comprises receiving, from the AR device, information indicating the position of the AR device relative to the display device.

In some aspects, process 900 includes receiving a report of a user interaction with at least one of the at least one object being displayed by the display device, and modifying a display of the at least one of the at least one object being displayed by the display device according to the user interaction.

In some aspects, modifying the display of the at least one of the at least one object being displayed by the display device according to the user interaction comprises at least one of transferring an object being displayed by the display device to the AR device and ceasing displaying the object by the display device, or transferring an object being displayed by the AR device as an AR image to the display device and displaying the object by the display device.

In some aspects, process 900 includes receiving, from the AR device, a time synchronization signal, and synchronizing timing of images being displayed by the display device according to the time synchronization signal. For example, if the display device is a light shutter type 3D display, the time-multiplexed images must be displayed in synchronization with the LCD shutter lenses of the AR device.

In some aspects, process 900 includes connecting to at least one other display device and operating with the at least one other display devices as a large, unified display to provide a single view, as individual displays displaying different views, or a combination thereof. For example, the multiple display devices can be connected together to become a large screen, like a TV wall, or the screens can be separately placed around the room, etc. Regardless of whether the display devices are grouped or separated, each screen can render the same virtual world, a completely different virtual world, or combinations thereof. When display devices are grouped, each screen may display its corresponding portion of a larger display comprising the combined area of the grouped display devices, which can provide a larger apparent depth of field.

Process 900 may include additional implementations, such as any single implementation or any combination of implementations described below and/or in connection with one or more other processes described elsewhere herein. Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

It is noted that the examples above involve an AR device having a camera or other type of image sensor, but the same principles may be applied to an AR device without an image sensor. Such an AR device can benefit from the operations that do not require an image sensor on the AR headset itself, including, but not limited to, using a display screen to extend field of view of the AR device, which can be performed by an AR headset without an image sensor where the position and orientation of the AR headset may be determined without using the visual field provided by an image sensor mounted onto the AR headset itself.

Some example use cases are now presented. The following example use cases are illustrative and not limiting. They are intended to illustrate various the use of capabilities of the AR system 200.

Example Use Case 1. A chief fashion designer may need to select a dress, a hat, and shoes from a large number of choices. In his or her office, there are several 3D screens: a first 3D screen shows dresses, a second 3D screen shows hats, a third 3D screen shows shoes, a fourth 3D screen is a “display cabinet” to show the selected dress, hat, and shoes.

The designer views a virtual fashion model that is displayed by the AR headset 100 (e.g., projected onto the lenses by projectors on the AR headset itself), and the designer can also see the 3D screens through the AR headset 100; the 3D images and scenes displayed on the 3D screens are viewed through the clear lenses of the AR headset 100, which may be polarized to different angles or may be light shutters, depending on the type of 3D screens in use.

To help the designer select a dress, the first 3D screen may show a set of dresses on virtual shelves or hangers, in rows or columns that may be zoomed in for a closer look at a smaller number of dresses at higher resolution or zoomed out to see a larger number of dresses at lower resolution. Using the shelf construct, the designer can put dresses on the shelves and stack the shelves. The designer can virtually move the shelves, and can rearrange the contents of the shelves, and the 3D image presented by the first 3D screen will be updated accordingly. As the designer moves around the first 3D screen, the 3D image on the first 3D screen changes accordingly, e.g., to mimic how the view of real dresses on real shelves would change as the designer moved around the room.

In some aspects, the designer can pick a dress and “pull” it closer to look at it in more detail, e.g., using a gesture. In some aspects, when a dress is picked from a virtual shelf displayed by the first 3D screen, the image of the dress disappears from the first 3D image and is instead generated by the AR headset. By doing this, the dress can be viewed anywhere that the designer is looking at through the AR headset, rather than being constrained to just the area of the first 3D screen. While being displayed by the AR headset, the designer may made adjustments to the dress, e.g., size, length, style, pattern, color, etc., and the AR headset will display the modified dress. In this example, if the designer does not like the dress, the designer can “push” the dress back, e.g., removing the dress from the AR display and instead displaying it on the first 3D screen. If the designer is satisfied with the dress, the designer can use it to clothe the virtual fashion model being displayed by the AR headset. The designer can then walk around the virtual fashion model and see how the dress looks.

The same actions can then be used to virtually try on different hats from the second 3D screen and to virtually try on different shoes from the third 3D screen, adjusting size, style, color, accessories, etc., until the virtual fashion model is wearing a combination of dress, hat, and shoes that satisfies the designer. The designer than may store the combination of dress, hat, and shoes to the fourth 3D screen which operates as a virtual display cabinet. During this process, the details of the objects being considered may be transferred between the 3D screen(s) to the AR headset.

Example Use Case 2. An immersive 3D environment may be created for a user of an AR headset using a set of 3D screens that act in concert to render an expansive 3D virtual world. In this use case, all of the 3D screens behave as windows into the same virtual world, but from different perspectives, just as each window in a bank of windows would show a slightly different view of the real world outside. In one implementation, all of the 3D screens receive a description of the same 3D scenario, but each 3D screen only renders the objects that an AR headset user would see, based on the user's relative position to the particular 3D screen.

For example, the 3D scenario may be a garden: as the AR headset moves, the 3D objects displayed by the 3D screen would move in the opposite direction, giving the illusion that the AR headset user was moving past a real window into a real world. The images generated by the 3D screens need not be static: in the garden example, trees displayed by the 3D screens may sway in the wind, birds may fly among the branches, or sing, and so on. In some aspects, multiple 3D screens may be grouped to form a large 3D screen, with each 3D screen rendering a view that corresponds to its position relative to the AR headset, just as panes of glass in a window would show a different view of the real world outside.

The systems and methods disclosed herein are not limited to the use of just one 3D screen, but may be extended to use multiple 3D screens. Since the virtual image on a 3D screen is generated by the 3D screen instead of by the AR headset, adding more 3D screens does not increase the rendering overhead of the AR headset, since each 3D screen is handling that aspect. The AR headset would need to be aware of the position of each 3D screen in actual space relative to itself, but handling each additional 3D screen is a relatively small incremental processing cost.

The techniques for using a display screen to extend field of view of an AR device described herein have a number of technical benefits. For example, unlike an AR display, which conventionally have a relatively narrow field of view (FOV), e.g., 90-100 degrees horizontally, the display screen can be used to place a virtual object or scene that can appear anywhere in the user's FOV, which is typically 180-190 degrees horizontally. Another advantage is that the display screen is not constrained by power, and can produce a very bright and real image. Yet another advantage is that existing AR headsets need only the addition of polarized glass or electronic shutter lenses to work with 3D displays. Polarized lenses have the advantages that they are inexpensive and easy to implement because they do not need any sync signal to or from the 3D screen. Electronic shutter glasses have the advantages that the light seen through the lenses will be normal (not polarized) and when the glasses are powered down they are still transparent, and that the resolution of electronic shutter glasses will be double that of polarized lenses.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

### Implementation Examples are Described in the Following Numbered Clauses

Clause 1. A method, performed by an augmented reality (AR) device having an image sensor, for extending the field of view of the AR device, the method comprising: establishing communications between the AR device and a display device having a display screen; time-synchronizing the display device to the AR device; determining a position of the display screen of the display device relative to the AR device; configuring content to be rendered on the display screen of the display device; and sending the content to the display device.

Clause 2. The method of clause 1, wherein establishing communications between the AR device and the display device comprises establishing communications between the AR device and a plurality of display devices, and wherein the plurality of display devices operates as a large, unified display to provide a single view, as individual displays displaying different views, or a combination thereof.

Clause 3. The method of any of clauses 1 to 2, further comprising, providing, to the display device, a time synchronization signal for synchronizing timing of images being displayed by the display device with an operation of the AR device.

Clause 4. The method of any of clauses 1 to 3, further comprising: determining a position of the AR device; reporting a position of the AR device to the display device; and requesting the display device to display at least one object according to the position of the AR device.

Clause 5. The method of clause 4, wherein determining the position of the AR device comprises at least one of: determining the position using radio frequency positioning techniques; or determining a size of the display screen of the display device and determining the position of the AR device based at least in part on visual information received by the image sensor, while ignoring visual information within the display screen of the display device.

Clause 6. The method of any of clauses 4 to 5, wherein determining the position of the AR device comprises performing a six-degree of freedom (6DOF) calculation.

Clause 7. The method of any of clauses 4 to 6, further comprising: reporting, to the display device, a user interaction with at least one of the at least one object being displayed by the display device.

Clause 8. The method of clause 7, further comprising, in response to the user interaction, at least one of: transferring an object being displayed by the display device to the AR device and displaying the object as an AR image; or transferring an object being displayed by the AR device as an AR image to the display device and ceasing displaying the object as an AR image.

Clause 9. The method of any of clauses 1 to 8, wherein the AR device comprises at least one lens through which the user can view a three-dimensional (3D) display for displaying pairs of images to simulate a 3D image, and wherein the display device comprises a 3D display.

Clause 10. A method, performed by a display device having a display screen, for extending the field of view of an augmented reality (AR) device, the method comprising: establishing communications between the display device and an AR device having an image sensor; time-synchronizing the display device to the AR device; determining a position of the AR device relative to the display device; receiving a request to display at least one object according to the position of the AR device; and displaying, on the display screen, the at least one object according to the position of the AR device.

Clause 11. The method of clause 10, wherein the display device comprises a three-dimensional (3D) display for displaying pairs of images to simulate a 3D image.

Clause 12. The method of any of clauses 10 to 11, wherein determining the position of the AR device relative to the display device comprises receiving, from the AR device, information indicating the position of the AR device relative to the display device.

Clause 13. The method of any of clauses 10 to 12, further comprising: receiving a report of a user interaction with at least one of the at least one object being displayed by the display device; and modifying a display of the at least one of the at least one object being displayed by the display device according to the user interaction.

Clause 14. The method of clause 13, wherein modifying the display of the at least one of the at least one object being displayed by the display device according to the user interaction comprises at least one of: transferring an object being displayed by the display device to the AR device and ceasing displaying the object by the display device; or transferring an object being displayed by the AR device as an AR image to the display device and displaying the object by the display device.

Clause 15. The method of any of clauses 10 to 14, further comprising: receiving, from the AR device, a time synchronization signal; and synchronizing timing of images being displayed by the display device according to the time synchronization signal.

Clause 16. The method of any of clauses 10 to 15, further comprising connecting to at least one other display device and operating with the at least one other display devices as a large, unified display to provide a single view, as individual displays displaying different views, or a combination thereof.

Clause 17. An augmented reality (AR) device, comprising: at least one lens through which a user can view a display; a projector for projecting an AR image onto the at least one lens for viewing by the user; an image sensor; a memory; at least one transceiver; and at least one processor communicatively coupled to the projector, the memory, and the at least one transceiver, the at least one processor configured to: establish communications with a display device having a display screen; time-synchronize the display device to the AR device; determine a position of the display screen of the display device relative to the AR device; configure content to be rendered on the display device; and send the content to the display device.

Clause 18. The AR device of clause 17, wherein the at least one processor is configured to connect to a plurality of display devices, wherein the plurality of display devices operate as a large, unified display to provide a single view, as individual displays displaying different views, or a combination thereof.

Clause 19. The AR device of any of clauses 17 to 18, wherein the at least one processor is further configured to provide, to the display device, a time synchronization signal for synchronizing timing of images being displayed by the display device with an operation of the AR device.

Clause 20. The AR device of any of clauses 17 to 19, wherein the at least one processor is further configured to: determine a position of the AR device; report a position of the AR device to the display device; and request the display device to display at least one object according to the position of the AR device.

Clause 21. The AR device of clause 20, wherein, to determine the position of the AR device, the at least one processor is further configured to at least one of: determine the position using radio frequency positioning techniques, or determine a size of the display screen of the display device and to determine the position of the AR device based at least in part on visual information received by the image sensor, while ignoring visual information within the display screen of the display device.

Clause 22. The AR device of any of clauses 20 to 21, wherein, to determine the position of the AR device, the at least one processor is configured to perform a six-degree of freedom (6DOF) calculation.

Clause 23. The AR device of any of clauses 20 to 22, wherein the at least one processor is further configured to: report, to the display device, a user interaction with at least one of the at least one object being displayed by the display device.

Clause 24. The AR device of clause 23, wherein the at least one processor is further configured to, in response to the user interaction, at least one of: transfer an object being displayed by the display device to the AR device and display the object as an AR image; or transfer an object being displayed by the AR device as an AR image to the display device and cease displaying the object as an AR image.

Clause 25. The AR device of any of clauses 17 to 24, wherein the at least one lens comprises at least one lens through which the user can view a three-dimensional (3D) display for displaying pairs of images to simulate a 3D image, and wherein the display device comprises a 3D display.

Clause 26. A display device, comprising: a display screen; a memory; at least one transceiver; and at least one processor communicatively coupled to the display screen, the memory, and the at least one transceiver, the at least one processor configured to: establish communications with an augmented reality (AR) device; synchronize a timestamp with the AR device; receive, via the at least one transceiver, a position of the AR device; receive, via the at least one transceiver, a request to display at least one object according to the position of the AR device; and display, on the display screen, the at least one object according to the position of the AR device.

Clause 27. The display device of clause 26, wherein the at least one processor is further configured to: receive, via the at least one transceiver, a report of a user interaction with at least one of the at least one object being displayed by the display device; and modify a display of the at least one of the at least one object being displayed by the display device according to the user interaction.

Clause 28. The display device of clause 27, wherein, to modify the display of the at least one of the at least one object being displayed by the display device according to the user interaction, the at least one processor is configured to: transfer an object being displayed by the display device to the AR device and ceasing displaying the object by the display device; or transfer an object being displayed by the AR device as an AR image to the display device and displaying the object by the display device.

Clause 29. The display device of any of clauses 26 to 28, wherein the display screen comprises a three dimensional (3D) display screen for displaying pairs of images to simulate a 3D image, wherein the 3D display screen displays a first image of a pair of images at a first polarization angle and displays a second image of the pair of images at a second polarization angle different from the first polarization angle, or alternately displays a first image of a pair of images and then a second image of the pair of images in a time multiplexed manner according to a time synchronization signal received from the AR device.

Clause 30. The display device of any of clauses 26 to 29, wherein the at least one processor is further configured to connect to at least one other display device and operate with the at least one other display device as a large, unified display to provide a single view, as individual displays displaying different views, or a combination thereof.

Clause 31. An apparatus comprising a memory, a transceiver, and a processor communicatively coupled to the memory and the transceiver, the memory, the transceiver, and the processor configured to perform a method according to any of clauses 1 to 16.

Clause 32. An apparatus comprising means for performing a method according to any of clauses 1 to 16.

Clause 33. A non-transitory computer-readable medium storing computer-executable instructions, the computer-executable comprising at least one instruction for causing a computer or processor to perform a method according to any of clauses 1 to 16.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method, performed by an augmented reality (AR) device having an image sensor, for extending a field of view of the AR device, the method comprising:
establishing communications between the AR device and a display device having a display screen;
time-synchronizing the display device to the AR device;
determining a position of the display screen of the display device relative to the AR device;
configuring content to be rendered on the display screen of the display device; and
sending the content to the display device.

2. The method of claim 1, wherein establishing communications between the AR device and the display device comprises establishing communications between the AR device and a plurality of display devices, and wherein the plurality of display devices operates as a large, unified display to provide a single view, as individual displays displaying different views, or a combination thereof.

3. The method of claim 1, further comprising, providing, to the display device, a time synchronization signal for synchronizing timing of images being displayed by the display device with an operation of the AR device.

4. The method of claim 1, further comprising:
determining a position of the AR device;
reporting a position of the AR device to the display device; and
requesting the display device to display at least one object according to the position of the AR device.

5. The method of claim 4, wherein determining the position of the AR device comprises at least one of:
determining the position using radio frequency positioning techniques; or
determining a size of the display screen of the display device and determining the position of the AR device based at least in part on visual information received by the image sensor, while ignoring visual information within the display screen of the display device.

6. The method of claim 4, wherein determining the position of the AR device comprises performing a six-degree of freedom (6DOF) calculation.

7. The method of claim 4, further comprising:
reporting, to the display device, a user interaction with at least one of the at least one object being displayed by the display device.

8. The method of claim 7, further comprising, in response to the user interaction, at least one of:
transferring an object being displayed by the display device to the AR device and displaying the object as an AR image; or
transferring an object being displayed by the AR device as an AR image to the display device and ceasing displaying the object as an AR image.

9. The method of claim 1, wherein the AR device comprises at least one lens through which a user of the AR device can view a three-dimensional (3D) display for displaying pairs of images to simulate a 3D image, and wherein the display device comprises a 3D display.

10. A method, performed by a display device having a display screen, for extending a field of view of an augmented reality (AR) device, the method comprising:
establishing communications between the display device and an AR device having an image sensor;
time-synchronizing the display device to the AR device;
determining a position of the AR device relative to the display device;
receiving a request to display at least one object according to the position of the AR device; and
displaying, on the display screen, the at least one object according to the position of the AR device.

11. The method of claim 10, wherein the display device comprises a three-dimensional (3D) display for displaying pairs of images to simulate a 3D image.

12. The method of claim 10, wherein determining the position of the AR device relative to the display device comprises receiving, from the AR device, information indicating the position of the AR device relative to the display device.

13. The method of claim 10, further comprising:
receiving a report of a user interaction with at least one of the at least one object being displayed by the display device; and
modifying a display of the at least one of the at least one object being displayed by the display device according to the user interaction.

14. The method of claim 13, wherein modifying the display of the at least one of the at least one object being displayed by the display device according to the user interaction comprises at least one of:
transferring an object being displayed by the display device to the AR device and ceasing displaying the object by the display device; or
transferring an object being displayed by the AR device as an AR image to the display device and displaying the object by the display device.

15. The method of claim 10, further comprising:
receiving, from the AR device, a time synchronization signal; and
synchronizing timing of images being displayed by the display device according to the time synchronization signal.

16. The method of claim 10, further comprising connecting to at least one other display device and operating with the at least one other display devices as a large, unified display to provide a single view, as individual displays displaying different views, or a combination thereof.

17. An augmented reality (AR) device, comprising:
at least one lens through which a user can view a display;
a projector for projecting an AR image onto the at least one lens for viewing by the user;
an image sensor;
a memory;
at least one transceiver; and
at least one processor communicatively coupled to the projector, the memory, and the at least one transceiver, the at least one processor configured to:
establish communications with a display device having a display screen;
time-synchronize the display device to the AR device;
determine a position of the display screen of the display device relative to the AR device;
configure content to be rendered on the display device; and
send the content to the display device.

18. The AR device of claim 17, wherein the at least one processor is configured to connect to a plurality of display devices, wherein the plurality of display devices operate as a large, unified display to provide a single view, as individual displays displaying different views, or a combination thereof.

19. The AR device of claim 17, wherein the at least one processor is further configured to provide, to the display device, a time synchronization signal for synchronizing timing of images being displayed by the display device with an operation of the AR device.

20. The AR device of claim 17, wherein the at least one processor is further configured to:
determine a position of the AR device;
report a position of the AR device to the display device; and
request the display device to display at least one object according to the position of the AR device.

21-30. (canceled)
